(19) United States
(12) Patent Application Publication
(10) Pub. No.: US 2006/0203311 A1
(43) Pub. Date: Sep. 14, 2006

(54) Automatic white balance method adaptive to digital color images

(76) Inventors: Ching-Chih Weng, Taipei City (TW); Homer H. Chen, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/293,298

(22) Filed: Dec. 5, 2005

(30) Foreign Application Priority Data
Mar. 10, 2005 (TW) 094107331

(51) Int. Cl. H04N 1/46

(52) U.S. Cl. 358/516

(57) ABSTRACT

An automatic white balance method for digital color images comprises an image statistics process for estimating reference white points in an image, and adjustment the image based on the reference white points. In this method, by dynamically thresholding the chrominance values of the image in the white point detection, the processing is adaptive to each image for better image quality with less computational complexity.

### FIELD OF THE INVENTION

The present invention is generally related to an image processing method and, more particularly, to an automatic white balance method adaptive to digital color images.

### BACKGROUND OF THE INVENTION

White balance plays an important role in digital image processing for high quality color images. For example, automatic white balance is an important function of digital stand-still cameras, and the goal of the white balance is to adjust the image such that it looks as if it is taken under canonical light. When an image of a scene is captured by a digital camera, the sensor response at each pixel depends on the illumination. That is, each pixel value recorded by the sensor is related to the color temperature of the light source. When a white object is illuminated under a low color temperature, it will appear reddish in the recorded image. Similarly, it will appear bluish under a high color temperature. The goal of the white balance is to have the processed image as the same as taken under canonical light. Generally, white balance algorithms consist of two steps. They first estimate the illumination, and then use the result obtained to compensate the image. To maintain the color constancy of an image taken under different light sources, computational color constancy algorithms have been applied to accomplish white balance for digital cameras, and there have been proposed various computational color constancy algorithms in literatures, including grey world, perfect reflector, gamut mapping, and color by correlation. Most of these algorithms make certain assumptions of the color distribution of the processed image. They differ in the way that the illumination is estimated. Illumination estimation is a challenging issue because the sensor response is controlled by many different factors such as object shape, illumination geometry, etc. These factors are difficult to separate in the illumination estimation step. In the image adjustment step, methods such as the Von Kries diagonal model can be used to scale the pixel values of the R, G, and B channels separately. The diagonal model holds when the frequency responses of the R, G, and B components are narrow band and do not overlap with each other, and the error of diagonal model is much smaller than that of the illumination estimation.

For further illustration, several existing popular automatic white balance algorithms, including grey world, perfect reflector, fuzzy rules method, and Chikane's method, are discussed hereof. The grey world algorithm works under the assumption that, given an image with sufficient color variations, the average of reflectance of a scene is achromatic, i.e., has some pre-specific grey value. The grey world method is one of the oldest and simplest and is still a popular technique. It basically works well when variety of colors are presented in an image. However, it fails when there are large objects with uniform color in an image. Particularly, the advantage of the grey world algorithm is that the computation is simple, and a satisfactory image quality can be obtained when there are enough color variations in the image, while the disadvantage is that it is hard to decide the grey value, especially when there is a large object with uniform color within the image. The perfect reflector algorithm is based on the assumption that the brightest pixel in an image corresponds to an object point on a glossy or specular surface, which conveys a great amount of information about the illumination of the scene. Specular or glossy surfaces reflect the actual color of the light source because their reflectance functions are constant over a wide range of wavelengths. The perfect reflector algorithm exploits this property for image adjustment. It locates the brightest pixel in an image and assigns it as the reference white point thereof. However, the disadvantage is that the luminance of the whole image changes from time to time, so it is hard to accurately detect the white point, and it often changes the brightness of the whole image. In the fuzzy rules method, the image is analyzed in the C_{b}-Cᵣ space. However, different colors show different deviations under different light sources in the C_{b}-Cᵣ space. FIG. 1 shows the deviations of different colors from their nominal positions in the C_{b}-Cᵣ space, in which symbol A is referred to the deflected direction of high color temperature and symbol B is referred to the deflected direction of low color temperature. It has been found that bright colors deviate more than dark colors and that the Cᵣ to C_{b} ratio of a white object is between −1.5 to −0.5. In this process, the channel gains in the processed image are adjusted until the weighted C_{b} and Cᵣ values near white balance. Several fuzzy rules are set based on the characteristics discussed above. A proposed fuzzy rules method at first divides the image into several regions, and the averages of Cᵣ and C_{b} within each region are calculated. Then the weighting factors for each regions are determined, based on the fuzzy control means, to calculate the evaluated Cᵣ′ and C_{b}′ of the whole image frame. The Cᵣ′ and C_{b}′ indicate the deviation of the image color from the white balance point, and these values are employed to obtain the gains for Cᵣ and C_{b} adjustment of each pixel. The procedure stated above will be performed iteratively until the results of Cᵣ′ and C_{b}′ are close to that of white balance point, and it thus requires great amount and time-consuming computations. The Chikane's method is based on the concept of pre-processing. Briefly, it comprises white object purification, white point detection, and white balance adjustment. In further detail, this method first applies histogram equalization on the input image to enhance the contrast of the image pixels, and then it determines the reference white points by using pre-defined threshold values of chrominance and luminance. The Chikane's method performs well for most images but it degrades when images have a relatively small number of white points, since the threshold values are determined in advance and are not adaptive to the processed images. In particular, the Chikane's method will produce unreasonable scene while purification.

Therefore, it is desired an automatic white balance method with less computational complexity for better image quality.

### SUMMARY OF THE INVENTION

Accordingly, one object of the present invention is to provide an automatic white balance method for processing digital color images.

More particularly, one object of the present invention is to provide an algorithm to estimate reference white points in images, and this algorithm is adaptive to each image under processing by dynamically thresholding the chrominance values thereof.

According to the present invention, a novel technique is proposed that uses image statistics instead of ad hoc assumptions to estimate the reference white points in images, and this method performs better than existing algorithms in chrominance test. Instead of using pre-defined or fixed threshold, the algorithm of the present invention uses dynamic threshold adaptive to each processed images for white point detection and is therefore more flexible than other existing ad hoc algorithms.

Similar to previous approaches, a method of the present invention comprises two steps: white point detection and white point adjustment.

In a white point detection, an image statistics process is performed to decide reference white points in an image. Particularly, the chrominance values of the image are dynamically thresholded to select the reference white points in the image, such that the determined reference white points are adaptive to each processed image. In one embodiment, a near white region is first defined in a chrominance space that consists of candidate reference white points, and then the reference white points are further selected therefrom. To choose the candidate reference white points, in one embodiment, the mean values of chrominance values in the image are calculated, and the average absolute differences of chrominance values of the image are also calculated from the mean values of chrominance values and the chrominance values of pixels in the image. Then, the near white region or the candidate reference white points are defined from those pixels whose chrominance values satisfy a dynamic threshold condition related to the mean values of chrominance values in the image and the average absolute differences of chrominance values of the image. Preferably, only those of the candidate reference white points having greater luminance values are selected as the reference white points. In some embodiments, an image to be estimated the reference white points thereof may be first converted from one color space to another, for example from the RGB color space to the YC_{b}Cᵣ color space, before the white point detection, and it may be converted back to the original color space or a third color space after the image is adjusted, depending on its further operations or applications.

After the reference white points are determined, the image is adjusted based on the reference white points. In one embodiment, the Von Kries model is used in this process. In one embodiment, the channel gains are derived from the mean values of the reference white points. Preferably, to maintain the luminance of the whole image at the same level, the maximum luminance value in the image is used in deriving the channel gains. In one embodiment, the channel gains are computed by dividing the maximum luminance value of the image pixels by the mean values of the reference white points for three channels, respectively. In one embodiment using the Von Kries diagonal model, the pixel values of each pixel in the image are adjusted by multiplying the original pixel values of that pixel by the channel gains for the three channels, respectively.

From an aspect of the present invention, the color constancy problem is solved by recovering the estimate of the scene illumination.

To enhance the robustness of the proposed methods, an image to be processed is partitioned into several regions and evaluated the mean values and the average absolute differences for each region as described above. If the average absolute differences of a region are too small, this region is discarded because it is supposed to have not enough color variation, and the final mean values and average absolute differences are obtained by taking the average of those regions that pass such additional processing. It helps preventing large uniform objects from affecting the result.

For evaluation of the proposed methods, there have tested an algorithm on fifty images taken under various light sources. The results show that the algorithm is superior or comparable to conventional methods in both objective and subjective evaluations, while the complexity of the algorithm is quite low, which makes it attractive for real world applications.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a diagram illustrating the color deviation under high and low temperature in the C_{b}-Cᵣ space;

FIG. 2 shows a flowchart for processing an image in one embodiment of the present invention;

FIG. 3 is a diagram illustrating a near white region estimated in the C_{b}-Cᵣ space according to the present invention; and

FIG. 4 is a diagram illustrating an image divided into twelve regions in a further embodiment of the present invention.

### DETAILED DESCRIPTION OF THE INVENTION

Generally, a process for color constancy of a digital color image comprises the steps: (a) input of a raw or rare image, (b) illumination estimation from the image, (c) color adjustment in the image, and (d) output of the processed image. The image before being processed may be one generated by a digital camera, or obtained from a storage device, and may probably have been pre-processed by software tool or hardware equipment. In the illumination estimation step, as described above, variety of algorithms are developed, usually based on assumptions about distributions of reflectance. The detail processing in methods of the present invention will be illustrated by embodiments hereinafter. For the color adjustment, the Von Kries diagonal model is often used, and that model will be also employed in the exemplary methods hereinafter for illustrating the principles of the present invention. From an aspect of the present invention, the proposed methods focus on solving the drawbacks of the white point detection in image processing algorithms.

Automatic white balance methods for processing digital color images according to the present invention comprise white point detection and white point adjustment. The reference white points are detected by using statistical characteristics of images. In particular, as opposed to pre-defined threshold in previous approaches, dynamic threshold is used to detect white points in images according to the present invention.

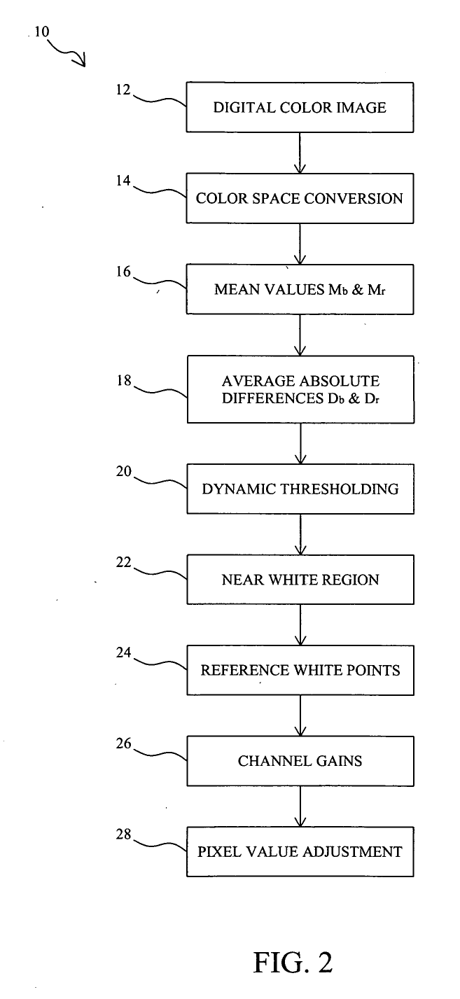

FIG. 2 shows a flowchart 10 for processing an image 12 in one embodiment of the present invention, which is designed for processing the image 12 in the YC_{b}Cᵣ color space, and in which white point detection includes steps 14 to 24 and white point adjustment includes steps 26 to 28. The image 12 may be an individual image or a part of a larger image. Referring to FIG. 2, the detail image processing will be pictured step by step in the following.

Step 14: Color Space Conversion

In state-of-art, a color is generally described by three channels, e.g., red, green, and blue channels in the RGB color space, or one luminance channel and two chrominance channels in the YC_{b}Cᵣ color space. A digital color image is composed of pixels, in which each pixel has three pixel values, for example color values of three colors or one luminance value and two chrominance values. The sensors of image generators, such as digital cameras, typically generate color values for the pixels thereof. Moreover, color values are typically employed in image storage. However, in image processing, the luminance and chrominance values of a color image are quite useful because they express color in a similar fashion to the way the human visual system operates. Luminance value of an image determines the sharpness of this image, and chrominance values determine its colorfulness. For image processing, an image may be converted between different color spaces. For example, when an image is converted from the RGB color space to the YC_{b}Cᵣ color space, the chrominance values C_{b} and Cᵣ are derived from the color value differences G-B and G-R. In some systems, the green color is also referred as the luminance, and the red and blue colors are referred as the chrominance. Sometimes an image is described in a color space that is not convenient for processing by desired algorithms or requires mass computations, then it will be converted to another color space in advance for simplifying the subsequent processing. In considering such cases, this embodiment is designed to process the image 12 originally recorded by the RGB components, which is generated by a digital camera or obtained from a storage device. For applying an automatic white balance method of the present invention to the image 12, it is first conversed from the RGB color space to the YC_{b}Cᵣ color space in step 14. The conversion between different color spaces is well known in the art.

In the subsequent process, a near white region is first estimated in a chrominance space, and the points in the near white region having luminance values above some threshold are considered white. In the designed embodiments hereof, the C_{b}-Cᵣ space is selected as the chrominance space to define the near white region thereof and only the top bright 10% of points in the near white region are selected to be white in one embodiment. The detail process will be described in the following step by step. However, those skilled in the art may easily make modifications and variations to part or all of the steps illustrated hereinafter in real applications from the exemplary process.

Step 16: Evaluation of the Mean Values of Chrominance Values

In this step, the mean values M_{b} and Mᵣ of the chrominance values C_{b} and Cᵣ in the image 12 are calculated, respectively.

In one embodiment, all pixels of the image 12 are selected to calculate the mean values M_{b} and Mᵣ. In another embodiment, only partial pixels of the image 12 are selected to calculate the mean values M_{b} and Mᵣ. Particularly, there may be those pixels around one or more regions of the image 12 are selected to calculate the mean values M_{b} and Mᵣ. The selection of pixels to calculate the mean values M_{b} and Mᵣ may depend on the preference of the operators, the image conditions, or the real applications.

Step 18: Estimation of the Average Absolute Differences

This step calculates the average absolute differences D_{b} and Dᵣ as follows:

$$\begin{matrix}{D}_{b} = {\sum }_{i , j} ( \vert {C}_{b} ( i , j ) {M}_{b} \vert ) / N , & [ EQ \text{-} 1 ] \\ {D}_{r} = {\sum }_{i , j} ( \vert {C}_{r} ( i , j ) {M}_{r} \vert ) / N , & [ EQ \text{-} 2 ]\end{matrix}$$

where C_{b}(i,j) and Cᵣ(i,j) are the chrominance values of pixel (i,j) used in the step 16 to calculate the mean values M_{b} and Mᵣ, and N is the number of those pixels.
Step 20: Dynamic Thresholding

The mean values M_{b} and Mᵣ, and the average absolute differences D_{b} and Dᵣ are used for dynamic thresholding. In particular, the near white region is composed of pixels that satisfy the following relationships:
|C_{b}(i,j)(M_{b}+D_{b}×sign(M_{b}))|<K₁×D_{b}, [EQ-3]
|Cᵣ(i,j)(K₁×Mᵣ+Dᵣ×sign(Mᵣ))|<K₁×Dᵣ, [EQ-4]
where K1 is a constant, and sign(M_{b}) and sign(Mᵣ) represent the plus or minus sign of M_{b} and Mᵣ. When M_{b} and Mᵣ are negative, the sign(M_{b}) and sign(Mᵣ) both equal to −1. When M_{b} and Mᵣ equal to zero, the sign(M_{b}) and sign(Mᵣ) are zero. When M_{b} and Mᵣ are positive, the sign(M_{b}) and sign(Mᵣ) both equal to 1. In other embodiment, the constant K1 in the equations EQ-3 and EQ-4 are adjustable.

From an aspect of the present invention, the threshold value employed in the white point detection is related to the image statistics, i.e., dynamic thresholding is applied to the chrominance values of the processed image, such that the process is adaptive to that image it is processing.

Step 22: Definition of the Near White Region

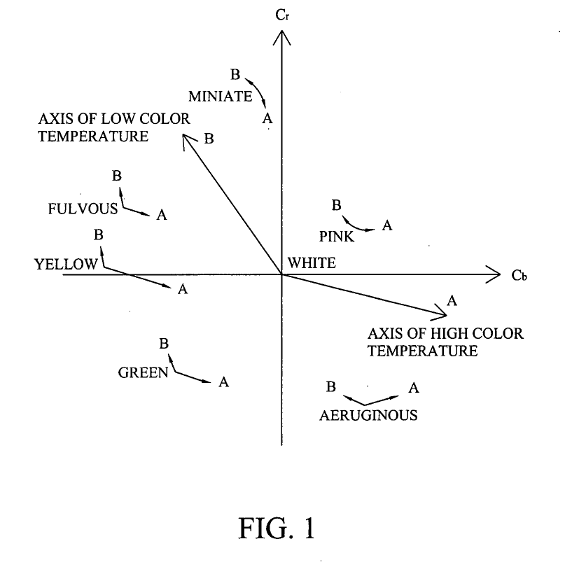

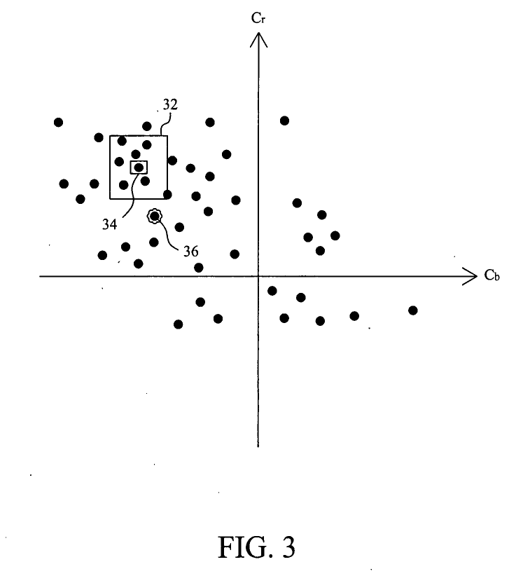

Based on the color characteristics illustrated in FIG. 1, the near white region will be defined as that consists of candidate reference white points. As stated in the step 20, the pixels satisfying the image statistics equations EQ-3 and EQ-4 are chosen as candidate reference white points. As shown in FIG. 3, those candidate reference white points constitute the near white region 32 in the C_{b}-Cᵣ space. FIG. 3 also shows the chrominance distribution of the image 12. The center of the near white region 32 is point 34, and the mean value of chrominance is point 36. In other embodiments, the constant K1 in the equations EQ-3 and EQ-4 may be modified to adjust the range of the near white region 32.

Step 24: Determination of the Reference White Points

Then, based on the luminance values, those of the candidate reference white points having greater luminance values, for example the top 10% thereof, in the near white region 32 are selected as the reference white points. In other embodiment, the luminance threshold for use to screen the reference white points from the candidate reference white points may be greater or less, such that less or more of the candidate reference white points will be selected to be white.

Step 26: Calculation of the Channel Gains

After the reference white points are determined, in one embodiment, the Von Kries model is used to adjust the image. Particularly, it is noted that diagonal model holds when camera sensor responses are narrow band and not overlapped to one another for different channels.

In one embodiment, to maintain the luminance of the whole image 12 at the same level, the maximum luminance value in the image 12 is used in deriving the channel gains. The channel gains R_{gain}, G_{gain}, and B_{gain} are computed by:
R_{gain}=Yₘₐₓ/R_{avew}, [EQ-5]
G_{gain}=Yₘₐₓ/G_{avew}, [EQ-6]
B_{gain}=Yₘₐₓ/B_{avew}, [EQ-7]
where R_{avew}, G_{avew}, and B_{avew} are the mean values of the reference white points for the three channels, and Yₘₐₓ is the maximum luminance value in the image 12. In other embodiments, the maximum luminance value Yₘₐₓ used in the equations EQ-5 to EQ-7 may be replaced with other values for normalizing the final adjusted image to a luminance level.
Step 28: Adjustment of Pixel Values

In one embodiment, according to the Von Kries diagonal model, the pixel values of each pixel in the image 12 are adjusted by:
R′=R×R_{gain}, [EQ-8]
G′=G×G_{gain}, [EQ-9]
B′=B×b_{gain}, [EQ-10]
where R, G and B are the original values of pixels in the image 12, and R′, G′, and B′ are the adjusted pixel values.

The superiority of methods according to the present invention is rooted on the fact that they use a dynamic threshold to determine the reference white points. It adapts to the image statistics and hence is able to capture the reference white points better than conventional techniques that use ad hoc rules. As a result of methods according to the present invention, it is obtained excellent color constancy for any image generator, i.e., colors of any scene recorded by a device such as a digital camera will be constant across the scene illumination to human eyes. Whenever a scene is captured by a digital camera, the image of the scene shows a distinct color cast depending on the light source, and the automatic white balance methods proposed hereof will improve the color constancy of the digital camera. However, methods of the present invention have much wider applications, for example in the cases of image reproduction, image recognition, computer vision, etc. Moreover, methods of the present invention are additionally featured in less computational complexity, which makes cost-efficient approaches available for realization in various products.

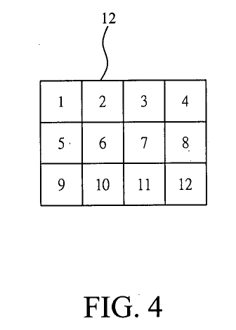

Enhancement may be implemented by introducing additional steps in a further embodiment. By illustrating in FIG. 4, the image 12 to be processed is divided into a plurality of regions, for example twelve regions as shown hereof, to calculate the mean values M_{b}'s and Mᵣ's of the chrominance values of pixels and the average absolute differences D_{b}'s and Dᵣ's in the twelve regions, respectively, as described in the foregoing steps. Then a preliminary screening is performed. Among the twelve regions, if there are any one or more of them have the average absolute differences D_{b}'s and Dᵣ's less than some threshold, they will be discarded because they are supposed to have not enough color variation. These additional steps help preventing large uniform objects from affecting the result. The final mean values M_{b}'s and Mᵣ's and average absolute differences D_{b}'s and Dᵣ's are obtained by taking the average of those regions that pass these additional steps, and following that, the near white region is obtained by using the equations EQ-3 and EQ-4 similarly for further extracting the reference white points, as described in the foregoing steps. In these additional steps, the regions divided from an image to be processed may have any number of regions, or any regular or irregular shapes, or any type of distribution in the image. Moreover, these region division and screening steps may be performed more than once in some other embodiments.

Alternatively, by using other tools, one or more objects or one or more regions in an image may be ignored before the image is taken into white point detection. It may help estimating the white points more precisely or reducing the computation amount when using methods of the present invention.

In order to get a better image quality, the M_{b}, Mᵣ, D_{b}, and Dᵣ may be calculated more than once with screened points in defining the near white region, and each time a new near white region and new reference white points may be obtained by using the equations as the above steps. The reference white points selected by such repeated cycles will be closer to the real white points in the image than those selected by only one cycle. As a result, the final image quality will be more improved.

According to the present invention, the dynamic threshold is derived from the color information of the image to be processed. For any image to be processed, the dynamic thresholding is best matched to the condition of the image itself, and thus the determined reference white points will be most precisely to the white points in the image. The above embodiments are illustrated in the YC_{b}Cᵣ color space, while in other embodiments, methods of the present invention are applied in other color spaces, such as the YUV or YCNk space. In some other embodiments, conversion between different color spaces may be performed more than once.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An automatic white balance method for digital color images, the method comprising the steps of:
performing an image statistics process for estimating reference white points in an image; and
adjusting the image based on the reference white points.

2. The method of claim 1, further comprising the step of converting the image from a first color space to a second color space for the image statistics process performed in the second color space.

3. The method of claim 2, wherein the second color space comprises a chrominance space.

4. The method of claim 2, wherein the first color space is one selected from the group composed of RGB, YC_{b}Cᵣ, YUV, and YCNk color spaces.

5. The method of claim 2, wherein the second color space is one selected from the group composed of RGB, YC_{b}Cᵣ, YUV, and YCNk color spaces.

6. The method of claim 1, wherein the step of performing an image statistics process comprises the step of white point detection using a dynamic threshold.

7. The method of claim 1, wherein the step of performing an image statistics process comprises the steps of:
evaluating average absolute differences in the image; and
determining the reference white points satisfying a dynamic threshold condition.

8. The method of claim 7, wherein the step of evaluating average absolute differences comprises the steps of:
estimating mean values of chrominance values in the image; and
deriving the average absolute differences of the image.

9. The method of claim 7, wherein the step of determining the reference white points comprises the steps of:
defining a near white region consisting of candidate reference white points in the image; and
selecting the reference white points from the candidate reference white points, each thereof having a luminance value greater than a luminance threshold.

10. The method of claim 7, wherein the step of determining the reference white points comprises the steps of:
defining a near white region consisting of candidate reference white points in the image; and
selecting the reference white points from the candidate reference white points that occupy a top percentage of the candidate reference white points in luminance value.

11. The method of claim 10, wherein the reference white points occupy 10% of the candidate reference white points in pixel number.

12. The method of claim 1, further comprising the step of evaluating if to discard a region of the image for the image statistics process performed with the other region of the image.

13. The method of claim 12, wherein the step of evaluating if to discard a region of the image comprises the steps of:
dividing the image into a plurality of regions;
evaluating color variation for each of the plurality of regions; and
discarding any one of the plurality of regions that does not have enough color variation.

14. The method of claim 13, wherein the step of evaluating color variation for each of the plurality of regions comprises the steps of:
for each of the plurality of regions, evaluating average absolute differences thereof; and
comparing the average absolute differences with a color variation threshold for each of the plurality of regions to determine if it has enough color variation.

15. The method of claim 14, wherein the step of evaluating average absolute differences for one of the plurality of regions comprises the steps of:
estimating mean values of chrominance values in the one region; and
deriving the average absolute differences of the one region.

16. The method of claim 1, wherein the step of adjusting the image comprises the steps of:
deriving channel gains based on the reference white points; and
scaling pixel values in the image with the channel gains.

17. The method of claim 16, wherein the step of deriving channel gains comprises the steps of:
estimating mean values of the reference white points; and
normalizing a luminance level of the image with the mean values for generating the channel gains.

18. The method of claim 17, wherein the step of normalizing a luminance level of the image with the mean values comprises dividing a luminance value selected from the image by the mean values, respectively.

19. The method of claim 17, wherein the luminance value selected from the image is the greatest one in the image.

20. An automatic white balance method for digital color images, the method comprising the steps of:
dynamically thresholding chrominance values in an image for estimating reference white points in the image; and
adjusting the image based on the reference white points.

21. The method of claim 20, further comprising the step of converting the image from a first color space to a second color space for the dynamical thresholding step is performed in the second color space.

22. The method of claim 21, wherein the second color space comprises a chrominance space.

23. The method of claim 21, wherein the first color space is one selected from the group composed of RGB, YC_{b}Cᵣ, YUV, and YCNk color spaces.

24. The method of claim 21, wherein the second color space is one selected from the group composed of RGB, YC_{b}Cᵣ, YUV, and YCNk color spaces.

25. The method of claim 20, wherein the dynamical thresholding step comprises the steps of:
evaluating average absolute differences in the image; and
determining the reference white points satisfying a dynamic threshold condition.

26. The method of claim 25, wherein the step of evaluating average absolute differences comprises the steps of:
estimating mean values of chrominance values in the image; and
deriving the average absolute differences of the image.

27. The method of claim 25, wherein the step of determining the reference white points comprises the steps of:
defining a near white region consisting of candidate reference white points in the image; and
selecting the reference white points from the candidate reference white points, each thereof having a luminance value greater than a luminance threshold.

28. The method of claim 25, wherein the step of determining the reference white points comprises the steps of:
defining a near white region consisting of candidate reference white points in the image; and
selecting the reference white points from the candidate reference white points that occupy a top percentage of the candidate reference white points in luminance value.

29. The method of claim 28, wherein the reference white points occupy 10% of the candidate reference white points in pixel number.

30. The method of claim 20, further comprising the step of evaluating if to discard a region of the image for the dynamical thresholding step performed with the other region of the image.

31. The method of claim 30, wherein the step of evaluating if to discard a region of the image comprises the steps of:
dividing the image into a plurality of regions;
evaluating color variation for each of the plurality of regions; and
discarding any one of the plurality of regions that does not have enough color variation.

32. The method of claim 31, wherein the step of evaluating color variation for each of the plurality of regions comprises the steps of:
for each of the plurality of regions, evaluating average absolute differences thereof; and
comparing the average absolute differences with a color variation threshold for each of the plurality of regions to determine if it has enough color variation.

33. The method of claim 32, wherein the step of evaluating average absolute differences for one of the plurality of regions comprises the steps of:
estimating mean values of chrominance values in the one region; and
deriving the average absolute differences of the one region.

34. The method of claim 20, wherein the step of adjusting the image comprises the steps of:
deriving channel gains based on the reference white points; and
scaling pixel values in the image with the channel gains.

35. The method of claim 34, wherein the step of deriving channel gains comprises the steps of:
estimating mean values of the reference white points; and
normalizing a luminance level of the image with the mean values for generating the channel gains.

36. The method of claim 35, wherein the step of normalizing a luminance level of the image with the mean values comprises dividing a luminance value selected from the image by the mean values, respectively.

37. The method of claim 36, wherein the luminance value selected from the image is the greatest one in the image.
